(19) United States
(12) Patent Application Publication
(10) Pub. No.: US 2001/0034659 A1
(43) Pub. Date: Oct. 25, 2001

(54) Simplified method and system for e-commerce operable in on-line and off -line modes

(75) Inventor: Hironori Kobayashi, New York, NY (US)

Correspondence Address: OSTROLENK FABER GERB & SOFFEN, 1180 AVENUE OF THE AMERICAS, NEW YORK, NY, 100368403

(73) Assignee: Mitsubishi International Corporation

(21) Appl. No.: 09/777,074

(22) Filed: Feb. 5, 2001

Related U.S. Application Data
(60) Provisional application No. 60/184,151, filed on Feb. 18, 2000.

(51) Int. Cl. G06F 17/60

(52) U.S. Cl. 705/26; 705/27

(57) ABSTRACT

A simplified method and system for e-commerce, which is operable in both on-line and off-line modes and in a manner which provides easy interface between entities providing products/services to the consuming public. A user tool is enabled to read identification indicia appearing on or in proximity to products or services and transmitting such information either wirelessly, or otherwise, to a central facility which carries out all of the necessary Internet searching to find information about the products/services. A consumer does not require to operate a PC or to have any knowledge concerning how to use, as by browsing or surfing the Internet, in order to procure information about products/services offered on the Internet.

### RELATED APPLICATION

This Application claims priority and is entitled to the filing date of U.S. Provisional Application Serial No. 60/184,151 filed Feb. 18, 2000, and entitled “SYSTEM AND METHOD FOR PORTABLE ELECTRONIC COMMERCE AND INFORMATION INTEGRATION, USING INTELLIGENT AGENTS.”

### BACKGROUND OF THE INVENTION

The present invention relates to e-commerce and, more particularly relates to a simplified method and system for e-commerce, which is operable in both on-line and off-line modes in a manner which provides easy interfacing between entities providing products/services and the consuming public, and allows commerce to be conducted at any place/any time, using public networks, such as cellular networks, the Internet and the like.

The advent of communication networks, such as the Internet, as well as wide-area networks (WAN) and the like, have opened vast channels for communications between the consuming public and purveyors and sellers of products, services and information. Presently, e-commerce systems and methods require customers to develop considerable familiarity with working such tools as personal computers (PC's) and/or the Internet and similar sophisticated systems. In typical prior art systems, customers for various products and services need to develop an ability to access the Internet and to surf and browse through a vast, indeed, virtually limitless, sea of information, provided by electronic shops and the like, to be able to find the products or services that they may be interested in. Typically, one has to be actively connected to the interfacing network, i.e., the Internet, during such browsing. One has to be able to find the Universal Resource Locators (URL) of the various electronic shops or business establishments which one needs to contact. It is not surprising that many consumers are still baffled by modern e-commerce, resulting in a considerable segment of the consuming public shunning e-commerce, despite the considerable benefits that can accrue from its use.

A very significant portion of conventional commerce is carried out through the use of catalogs, mail order systems, and advertisements via the print and television medias. Shopping by using catalogs, mail order literature and the like is relatively easy. Printed and visual media don't require technical knowledge to “browse” and shop. For example, mail order literature is highly suited to describe and depict a great variety of goods, as is reflected by the vast commerce that is carried out in this mode.

However, mail order catalogs and magazines (obviously) cannot be connected to electronic networks, or to the Internet, and the vast information in them cannot provide an instant or easy access to electronic-based commerce. Mail order customers, therefore, continue to complete their transactions by telephone or mail. The world of mail order technology and systems has not as yet been tightly linked with the world of e-commerce.

There exist a variety of devices and techniques which facilitate man-machine interface. These include bar code scanners, automated optical character recognition systems, voice recognition systems and the like. To date, these technological devices have been mainly used in business applications, in closed, stand-alone networks, such as in manufacturing plants, warehouses, shipping stores and the like. Furthermore, the intelligence of such known man-machine interfaces is presently located within the terminal or geographically very close to the terminal through which information is inputted. Consequently, the implementation of such interfaces tends to be more expensive and its wide-spread applicability has been hampered.

Another drawback of the prior art ensues from the fact that so-called “agent technologies” i.e., electronic interfacing systems to customers, only accept customer requests while customers are on-line, i.e., logged on. Moreover, such prior art systems demand that customers remain on-line at the same terminal until the entire transaction has been completed.

As defined above, an “agent” is an interface between a user or a customer and the e-commerce world. Today's agent-based, e-commerce systems do not permit a customer to select “agent” types. There is no concept of a “selectable agent” that is tailored to suit customer preferences. Hence, the prior art does not provide selectable agent systems which would allow, for example, the same sensor/scanner or even the same customer/product ID code to work differently based on specific applications. Were such a system provided, it would have allowed the selecting/downloading of user-selectable e-agents, enabling customers to receive different recommendations or advice from different e-agents. The absence of such “selectable agent” technology has prevented the prior art from enabling consumers to select or download specific e-agents for different purposes, while using the same terminal in interfacing with any or all of them.

Present technology requires customers to specifically locate, from enormous amounts of public information, the appropriate home pages of specific business establishments, and then find web pages within such home pages where the specific items of information that they are seeking is located. This is too difficult for many consumers.

There is a need in commerce to provide a more simplified method and system for e-commerce, which has great versatility and applicability, such that it can be used seamlessly with a great variety of e-commerce establishments without requiring users to master PC and Internet methods and technology.

### SUMMARY OF THE INVENTION

It is an object of the present invention to provide a system and method for e-commerce which is more simple to use and operate by consumers and vendors alike.

It is another object of the present invention to provide a simplified method and system for e-commerce which does not require the purchase by consumers of expensive PC-type equipment or tools.

It is a further object of the invention to provide a simple, easy to use and preferably hand held interface tool for conducting e-commerce activities.

It is a further object of the invention to provide a technologically simple tool which is able to provide access to the vast amounts of data that are resident on the Internet and private exchanges, including access to vendors of products and services.

The foregoing and other objects of the invention are realized by an e-commerce system and method which has two key constituents. These are a customer-based interface tool and a network-based selectable e-agent which provides an interface to the larger e-commerce world that resides on the Internet and/or to other information networks where the ultimate information is located.

The customer-based tool can be any of a variety of devices such as scanners, sensors, mobile terminals such as mobile phones, digital cameras, watches with image sensing, computer mouses and the like. The consumer tool can operate optically, magnetically, by means of infrared or sound or with bio sensors or any other sensor functions. The tool can also be incorporated in two-way pagers, cable TV set top boxes, game machines, in virtually any electronic device.

Essentially, the invention is a system and method for convenient real-time or delayed-access delivery of interactive information retrieval, product ordering, sales, marketing utilizing both the Internet or other public networks, wired as well as wireless. For instance, a cellular telephone or other portable or hand held device may be equipped with interfaces for obtaining information or ordering goods and services through the Internet.

The required sensor and/or scanner technology is well known in the art and does not require specific description herein. Representative patent literature describing such technology includes, U.S. Pat. Nos.: 5,932,860; 5,710,844; 5,656,805; 5,630,168; 5,506,394; 5,115,230; 4,748,318; 4,677,428; and 4,146,782. The contents of the aforementioned patents is incorporated by reference herein.

The “e-agent” component of the invention comprises a substantial, computer-based system and operation that is intended to serve as an interface or buffer between the simple consumer-based scanner/sensor tools and the e-commerce world beyond. The e-agent is able to translate simple requests for specific products or services to the appropriate instructions that allow it to reach the ultimate suppliers of the specific product(s) or service(s) or information and then cull from that information the specific information needed for the consumer. The e-agent then transmits the same to the consumer and ultimately closes a transaction in this manner without requiring the consumer to master PC technology or surf or browse the Internet as in conventional technology.

The applicability of the invention is contemplated in an e-commerce world in which products or services will carry specific marking, such as bar codes or invisible imprints or electronic tags etc. which will be unique to each product or service, to allow the identity of that product to be transmitted to the e-agent. The e-agent is able to translate that code as an address to one or more providers of the specific products or services for which information has been requested and/or for which a purchase order has been submitted.

As such, the hand held component of the invention is essentially a scanner that scans “hard copy” product literature or information which is typically provided in magazines or catalogs or on products and communicates identification codes displayed relative to products to the e-agent for instantaneous ordering of the products or services.

The hand held customer tool, which as noted can be a telephone/cellular phone based scanner, need not be connected to the e-agent on-line. Thus, the user can scan one or several pieces of bar coded information relative to different physical objects at the same or different locations for later on-line retrieval of information or on-line shopping in connection with such objects or locations. Other forms of input include auditory inputs such as voice commands or other recognizable sonic signals that the hand held unit may decode and transmit to the e-agent concerning customers' desires to order products or services or to retrieve or store desired information. For example, a customer may state the model number of a particular product and software in the e-agent component of the invention includes speech recognition routines that are designed to identify the specific product by understanding its model number, including manufacturer name or other indicia.

Other forms of input may include biometric sensors, such that the end user's physical state of being may be sensed by the portable device and desired information regarding such biometric parameters may be transmitted through the Internet or otherwise for processing, storage or other action by remote service providers. The hand held sensor device of the invention may comprise a miniature camera for forming an image of a desired product for transmitting to the e-agent. In this mode of operation, the e-agent responds by attempting to find a match in its database for the image or image signature provided from the customer tool. This embodiment seeks to allow the system of the invention to operate even without there appearing a special indicia next to products or services in catalogs or other types of newsprint.

The e-agent component of the invention may include multiple intelligent agents, i.e., computer routines utilizing a form of artificial intelligence, that may be “dispatched” on behalf of the end user to perform specified tasks within the network (e.g., the Internet). As an example, an intelligent “shopping agent” acts on behalf of a user who has used his portable terminal to request information about, or order, a given product such that the shopping agent will then search the Internet for the least expensive price for such product, or for other products having similar or compatible features. This enhances the interactive shopping transaction for the user, while maintaining the minimal effort and minimal-input advantages of the portable units integration with real-world items. The e-agent component may include a database of information that allows it to contact the ultimate providers of goods, services and information, by using the special product indicia of the present invention, or the bar code, or other information as an index to the URL's or other contact information for such providers.

The information is then returned to the portable user which may incorporate a display on which relevant information is provided to the end user. That information may be the price of an item, or a delivery date, or the order status date etc. The end user may then operate appropriate buttons or other controls on the end user tool to either close a transaction or to learn about its status etc. Alternatively, the e-agent may return to the portable tool digital information which can then be stored and played audibly to the end user. Or the e-agent may call the telephone of which the tool is a part and play a message representing the results of the search or the request for information. Another expedient of the invention involves the e-agent sending an e-mail or a facsimile letter or the like to a pre stored e-mail address of the user.

The advantages of the invention include:

(a) portability;

(b) ease of access to the Internet, and functionality and services even for users who do not have, or are not familiar with use of home or office computer terminals or Internet Service Providers (ISPs);

(c) instantaneous gratification of a user's desire to order products, obtain information, track order status etc. even when he or she is not near an Internet terminal, such as PCs, or does not wish to enter a lengthy URL or perform a web search;

(d) effective integration of the physical world, e.g. paper catalogs, as inputs for virtual transactions over the Internet;

(e) the combination of efficient agent technology and portable end user units, to enhance the goods, services, and information that may be offered and delivered to end users with minimal effort; and

(f) the ability to initiate or perform Internet transactions for storage or later processing, when the end user's remote access device is off-line or otherwise not able to be in instantaneous real-time contact with the Internet.

Other features and advantages of the present invention will become apparent from the following description of the invention which refers to the accompanying drawings.

### BRIEF DESCRIPTION OF THE DRAWINGS

FIG. 1 diagrammatically illustrates the key components and concept of the present invention.

FIG. 2 provides physical illustrations of customer tools and their manner of interfacing with the e-agents.

FIG. 3 is a flow chart of the main steps of the method of the present invention.

FIG. 4 is a block diagram of the salient components of the invention, illustrating the manner in which data and goods are exchanged.

FIG. 5 is an adaptation of FIG. 4 showing information flow from customers to e-commerce establishments.

FIG. 6 is an adaptation of FIG. 4 showing information flow from e-commerce establishments to ultimate consumers.

FIGS. 7A-7C are flow charts of certain software components of the invention.

### DETAILED DESCRIPTION OF EMBODIMENTS OF THE INVENTION

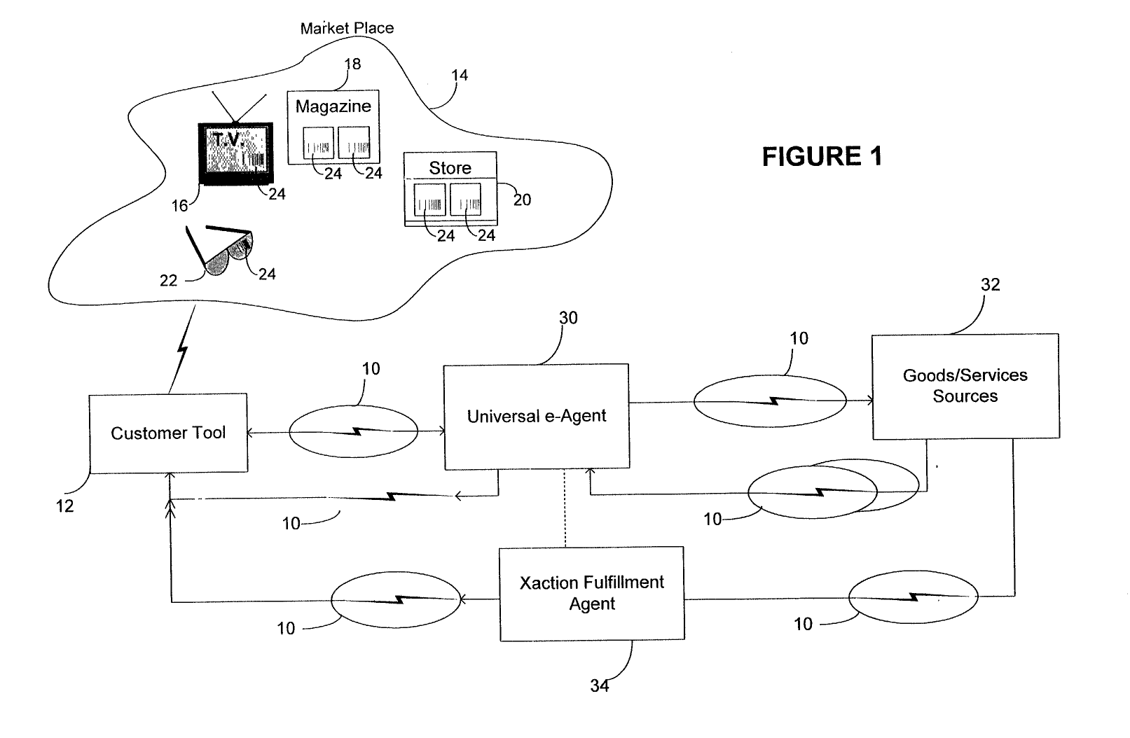

With reference to the drawings, FIG. 1 provides an overview of the salient features of the invention through its depiction of a marketplace 14 for products, services and information with which a customer interacts through the use of a customer tool 12, by communicating with a universal e-agent 30 which then scours sources 32 for such goods, services and information, identifying specific sources and eventually mediating and handling transactions between consumers and such goods/services sources or providers.

More specifically, in accordance with the present invention, goods, services and the like, —which are typically advertised or displayed or made available in the marketplace 14 such as on television 16, or in magazines or print media 18 or on store shelves 20 or as products 24—are all made to carry unique item identifying indicia 24 which can comprise a bar code or a symbol or an electronically embedded code or an RF tag or an invisibly provided indicia or even an image of the item, all of which can be sensed or read by the customer tool 12. The customer tool 12 has the capability of communicating that unique item indicia to the universal e-agent 30 for the purpose of either obtaining additional information about the item or for effectuating a transaction such as the purchasing thereof. The customer tool is any of the existing products or retrofitted products that is equipped with a scanner or sensor to read the image or the other form in which the indicia 24 is provided on the actual products or services.

The tool, as previously noted, can be a sensor or a scanner of any type, e.g., optical, magnetic, infrared, sound, or biological. This sensor can be provided in a variety of tools such as in a mobile phone, a two-way pager, a PC mouse, a CATV set top box, a digital camera, a watch, game machines, the list being endless. The essential point is that the tool 12 is capable of “reading” the indicia 24 provided next to a product, or with a service advertised in a magazine, or simply information that is made available. Such a tool can be pointed toward one's TV set on which a bar code is displayed next to an item being advertised. Or it can scan over pages in printed media. Or it can read indicia 24 on the actual products located in stores or in one's home or office, etc.

Since the tool 12 can be, for example, a cellular phone, equipped with a scanner and appropriate intelligence to communicate with the universal e-agent facility 30, the invention preferably allows communications between the customer tools 12, the e-agent 30 and the sources 32 over the Internet 10, as indicated in FIG. 1. The transaction fulfillment agent 34 is a constituent of the agent 30, that has been separately illustrated to show that once a customer has made a purchasing decision relative to a particular item, it is within the ambit of the invention that the source 32 may communicate relevant information either to the e-agent 30, or to the customer tool 12 if it has been programmed to follow appropriate protocols.

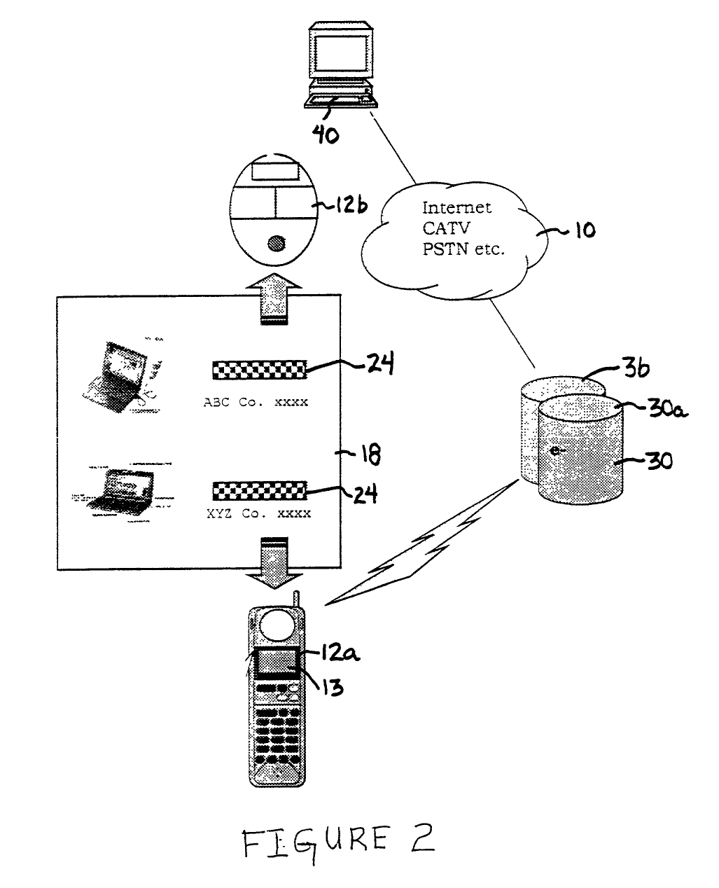

FIG. 2 is a more graphically-friendly illustration of the invention showing the tool 12 constituting a mobile telephone 12a with a special display scanner 13 for effecting communications with the universal e-agent 30. Alternatively, the Figure shows that the tool is the mouse with a special scanner 12b that is tethered to a PC 40 and which is able to communicate with the e-agent 30, which consists of component 30a and 30b, through the Internet, or cable TV, or PSTN, etc.

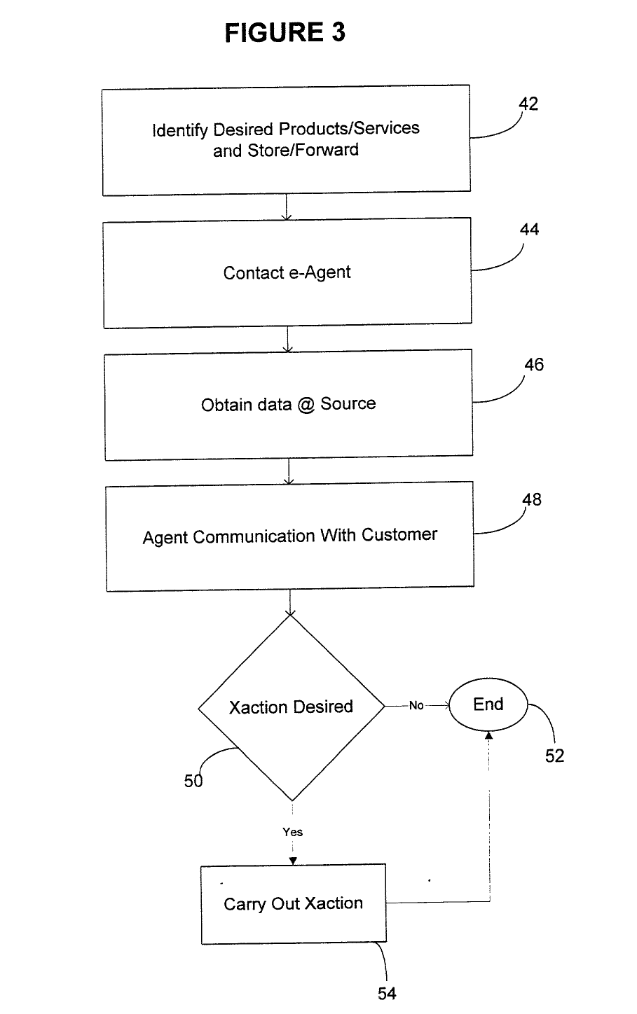

Similarly, the methodology of the present invention as depicted in the main software flow chart of FIG. 3 consists of a first step 42, which comprises identifying desired products or services for which information is desired and storing that information within the tool 12 for immediate or delayed transmission to the e-agent 30 as indicated at step 44.

The e-agent 30 then proceeds to obtain the relevant data from the sources 32 after consulting internal databases described further on. The next step 48 involves the e-agent communicating with the tool 12 to provide results as to either the source of information and its availability, or price, or other desired criteria. At the decisional box 50, it is determined whether a transaction between the user and the sources 32 for the products or services is desired. If no, the program terminates at step 52. Otherwise, the transaction is carried out at step 54.

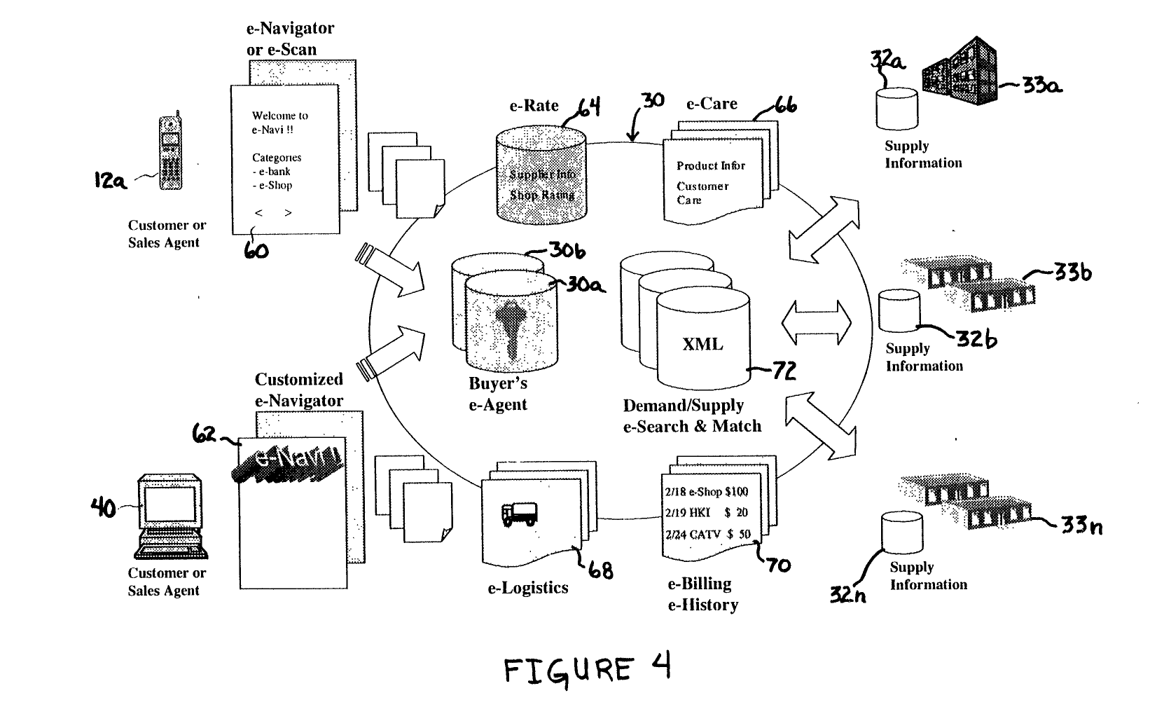

FIG. 4 provides still further details of the invention showing that the customer tools 12a or the PC 40 navigate with the e-agent facility 30 via an e-navigator or e-scan 60 or customized e-navigator 62 facilities which provide the information from the tools 12 to a buyer's e-agent 30a and 30b and that the overall software of the e-agent 30 also includes an e-rate facility 64 which contains supplier information and shop rating, an e-care facility 66 which is also a database of product information and customer care information and a main processing XML facility 72 which handles the demand and the supply and searches for the relevant information and matches requests from the tools 12 with products or services or information which is resident at the various suppliers 32 on the Internet, including the suppliers 33a, 33_{b} . . . 33ₙ, which contain respective supply information stores 32a, 32_{b} . . . 32ₙ.

A further element of the overall universal e-agent is the software facility 70 for handling billing as well as customer data history. Another facility 68 handles the logistics for physically or electronically transporting the desired items, for example, products or services.

As described above, the invention creates an interactive connection between the universal marketplace and customers, which is effected without requiring the multitudes of customers and seekers of information to master PC technology or to even understand the Internet or to learn the intricacies of surfing and browsing the World Wide Web. An essential component is the customer tool 12 which can be provided in a great variety of forms as already noted. The invention prefers that products, services or information be marked with item identification indicia (ID) 24 to be shown in catalogs, magazines, newspapers or on products or on television or any print or visual media which consumers can view.

There are two activation categories to activate the e-agent features. One is the “Customer Active Trigger” (CAT) which produces messages that are read actively by the customer using the customer tool 12, and communicated further as described. The ID code itself can be the same as has been used in the past in the form of bar codes and the like. Or the Customer may speak into the tool 12 which has voice recognition software to interpret it. Alternatively, the tool 12 forwards a digitized version of the voice commands to the e-agent 30.

In accordance with the second category, the sensor/scanner tool 12 can also be used to automatically detect a status change and thereby trigger communication with an e-agent 30. For example, if the tool 12 comprises a cell phone with a location sensor, when the customer changes geographic locations, a trigger occurs that causes information to be automatically communicated to the e-agent 30. The occurrence of such triggers is referred to herein as the “customer unconscious trigger” (“CUT”).

With the invention, customers can “browse” the entire world-wide information store that is available in catalogs, magazines or even on the Internet or indeed anywhere, to find candidate products, services or information that customers may desire to obtain. When the customer is ready, he or she can select customer selectable e-agents or an application specific e-agent (or the system will automatically select a default e-agent) which is suited for the particular product or information. In conjunction with the selected e-agent, the tool scans, senses or otherwise inputs the ID code of the product or services by means of the tool 12 which can be a cellular phone, or a PC mouse, etc. providing exceedingly simple and straight forward data input.

In a case where software was initiated by a CUT trigger, the sensor/scanner keeps monitoring status changes and triggers a process which communicates to the agent information such as the customer's location or the customer's health, etc. The trigger can be specific music that is being heard. When a change in customer status happens, the tool employs special e-agent software to automatically detect and cause the necessary triggering activities.

In both CAT and CUT, the terminal at the customer tool 12 automatically posts the CAT or CUT to the responsible e-agent within the e-agent network 30 through any means of communication and proceeds to obtain the necessary information for the customer.

The facilities in the e-agent 30 distinguish, recognize, decode and analyze the CAT/CUT, and search the network database for products/services, information or content, including text/graphic/music/voice/video files, based on customer's requests as reflected in the transmitted CAT/CUT, all automatically. The e-agent facility 30 saves the information/content or the linked data to the information content. The e-agent also saves updated transaction and customer status, including customer ID and/or customer location. This is done at the network site, by memorizing the updated transaction status and customer status. Therefore, the customers do not have to stay connected with the e-agent until a transaction is completed. Customers can terminate and resume the transaction at any time, from any terminal.

The information or content in the network database 30 including in such database facilities as identified by elements 64, 66 and 72 of FIG. 4, is quite obviously continuously updated. Some of the information or content can be commonly shared among a plurality of various agents which are tailored for different tasks. This includes standard product information, so different pieces of information can be collated, shared and otherwise manipulated to achieve system efficiencies, including saving costs and time to gather updated information. Other information or content can be partitioned and/or restricted for specific e-agent's use, for example, through the creation of a virtual private database to differentiate each e-agent or to secure private and secret information.

The invention has been depicted and described in a form in which the e-agent functionality is located in a central network. It is, however, possible to split the e-agent functions between a central and other locations, for example, by providing components thereof in the customer tools which, as noted, can be positioned now as a “terminal” e-agent. By judicious splitting of functionality, the invention further assures that customers do not have to be careful whether they are on-line or off-line or whether they are in a situation where communication is not possible.

Customers can post their demands and requests at any time, anywhere, even during off-line hours, using the terminal e-agent function. The terminal e-agent functionality can thus “hear and watch and store” the customer requests (CAT) or customer status changes (CUT) at the customer terminal end and automatically convey the information to the network e-agent 30 when the network, such as a Cellular Network, has become available.

Preferably, the network-based e-agent 30 keeps track of transactions status including order/request status and customer status information such as customer locations and the like. If the network e-agent 30 finds status changes, for example, delivery status changes, flight schedule changes or stock price changes, new product releases, etc., the network e-agent and the terminal e-agent jointly work to push the information to the customers wherever and as soon as the network is available for communication. Such network-based triggers are referred to herein as “Network Trigger (NT).”

The functionality of the customer tool, which is the scanner/sensor, is also deployed to identify and authenticate customers, to select application specific e-agents, to post customer information such as credit card numbers, mailing addresses and the like, and/or to post merchant/distribution numbers etc.

The present invention provides many benefits and has wide-scope applicability. Unlike the prior art, the present invention does not require customers or individuals to establish direct communication with sources of information by surfing the World Wide Web over the Internet. The present invention similarly does not require active connection between customers and the sources of information. The invention does not require people to be familiar with PC technology and is more accessible to the substantial segment of the population which is intimidated by technology in the form of computers etc.

The system and method of the present invention is essentially a point and click system which substantially automatically accomplishes its ends without the ultimate consumer having to be directly involved in accessing the Internet. The consumer does not see or need to see a web page, does not require to be tethered to a computer, does not require to key extensive information via a keyboard and can take any form, including something as simple as a cell phone or a PDA or the like.

The applicability of the invention is virtually without bounds. It can be used to purchase products, sell products, borrow products and services or even pay bills, including restaurant bills and the like. The invention effectively establishes an intimate relationship between real world shopping, such as by physically browsing through shelves in stores or viewing mail order catalogs and the like and electronic commerce. The invention selects for customers the appropriate e-agent facility to thereby enable them to find what they are searching for in the form of goods/services and information over the Internet without actually being exposed to the Internet.

The invention enables the creation of “real browsing shop” businesses. The invention enables creation of a “real-browsing shop” which consists of an entity that merely shows just samples of products and services. Users can “see and touch” demonstrations or sample goods and find the ones that best fit their needs. After finding desired products or services, users do nothing more than scan the code attached or displayed with the sample. All of the steps involving the ordering, delivery etc. are carried out through the network. Such a business model does not require a business establishment to have inventories.

Another application involves repeat order and direct e-commerce. By printing ID codes on the products which users usually buy, suppliers are able to create repeat order data and shift their business from real world to e-commerce sales more smoothly. Users still initially buy products from real, conventional shopping stores. However, they can and will likely fulfill their repeat orders through lower priced establishments over the Internet by using the scanning technology of the present invention.

Another application comprises network-enabled biosensor/medicine. Because of rapid progress of biological technology and gene analysis, enormous information on health and disease is becoming available on the Internet. By adding a bio sensor interface, the customer tool enables selecting an e-agent which is specialized for bio analysis. Users thereby receive updated health and disease information which is relevant to the user's own real world bio data.

Another application for the invention is in game machines, for example, an application where customers upgrade or download the “Monster” game easily by just scanning a “Monster ID” ad in magazines, TV, movies, events etc., using a special game machine with this invention function. For example, if a customer wants to add a special function to the game, the game supplier can print and distribute the ID code of the special function which is scanned and automatically downloaded into the game thereby expanding the market for such a game and character licensing. Or, a game program manufacturer can create virtual and real role playing games, which call on the players to go to certain places, such as convenience stores in the real world to obtain the “password” for upgrades of the character.

Another application is a navigation assistant, obtained by adding an ID code on business cards or on restaurant guides and selecting e-agent software to provide navigation instructions to desired establishments starting from the current location of the customer. It is within the ambit of the invention to include in the customer tool 12 a global positioning system (GPS) to improve the navigation assistance applicability of the invention.

Another application for the invention is the updating of information in magazines. For example, by adding an ID code on hotels/tour magazines, hotel or tourist agencies can inform customers of seasonal or even today's special prices through better and more frequent communication with customers.

The present invention is essentially implementable with existing components and technology which are combined to achieve the specific desired functionality.

Each e-agent is intended to be specialized for a particular application. Network service software to manage the overall system and the physical interface between the sensors and terminals are unique to the design choice that one seeks for a particular embodiment of the invention and is all within the ambit of one of ordinary skill in the art. As noted, the invention can make use of conventional scanners and sensors which can be bar code readers and the like, as already noted, as well as databases which can be organized as XML or other standard-based databases and the like. Application/session protocols can be WAP, HTTP, HDTP, etc. Transport protocols can be any of a variety of known protocols including TCP, UDP, etc. Network/datalink protocols can be IP or mobile protocol (CDMA, TDMA, etc.), PSTN, ISDN, ATM and the like.

With further reference to FIG. 4, the e-navigator and e-agent relationship is that the e-navigator 60 is a user interface which helps customers post their demands and needs into a secure virtual private e-agent. The e-agent 30 is the “behind the scene” manager, which saves customer information, purchase history, and provides e-solutions such as e-search and match to match customers demands with supplier information; as well as e-care (product and customer care information); e-billing (EBPPP, e-history; and e-logistics (delivery information).

By opening an application program interface (API) between the e-navigator and the e-agent, anyone can design any “plug-in” customized e-navigators. E-scan is one of several applications which are specialized for mobile and remote users.

There are a variety of applications which can make use of customized e-navigators. These include: a specific TV/movie programming or magazine-related e-commerce. Another example is a specific marketing tool for an enterprise customer such as an insurance agent, car dealer, etc. The invention works with any media, including PC or mobile phones, etc. which eliminates the limitations of being tethered to a physical location. Furthermore, the invention creates WAP and compact HTML interoperable and “layer-structure” DTD for XML databases and e-navigator content. The mobile terminal, i.e., the customer tool 12, can be used as the “e-scan” component which helps customers easily post their requests to the e-agent. While the e-navigator is more personalized, the e-agent is more the background manager for each customer and is able to save customer information, including credit card numbers, mobile numbers, etc., purchase history and provide total solutions. The e-search and match component searches and finds out the best products/services to fit each customer requests. It provides XML-based forms to assist filling out requirements for customers and product/service specifications for suppliers. It creates virtual private XML databases for specific e-navigators to differentiate one agent from another. It also collects marketing statistics for suppliers.

The e-care component works with an e-navigator and provides product/service comparison information and advice. It simulates and searches for best matches for customer's requests. It provides manual FAQ on the products/services in cooperation with suppliers and it interfaces with call centers.

The e-rate component provides supplier and distributor ratings while the e-billing EBPP consolidates customer's e-account, including credit card, bank account, a security account and assists in management of personal assets. Customer's purchase history and repeat order functions are saved in the e-history component. The e-logistic component is associated with the transportation function and provides updated delivery information.

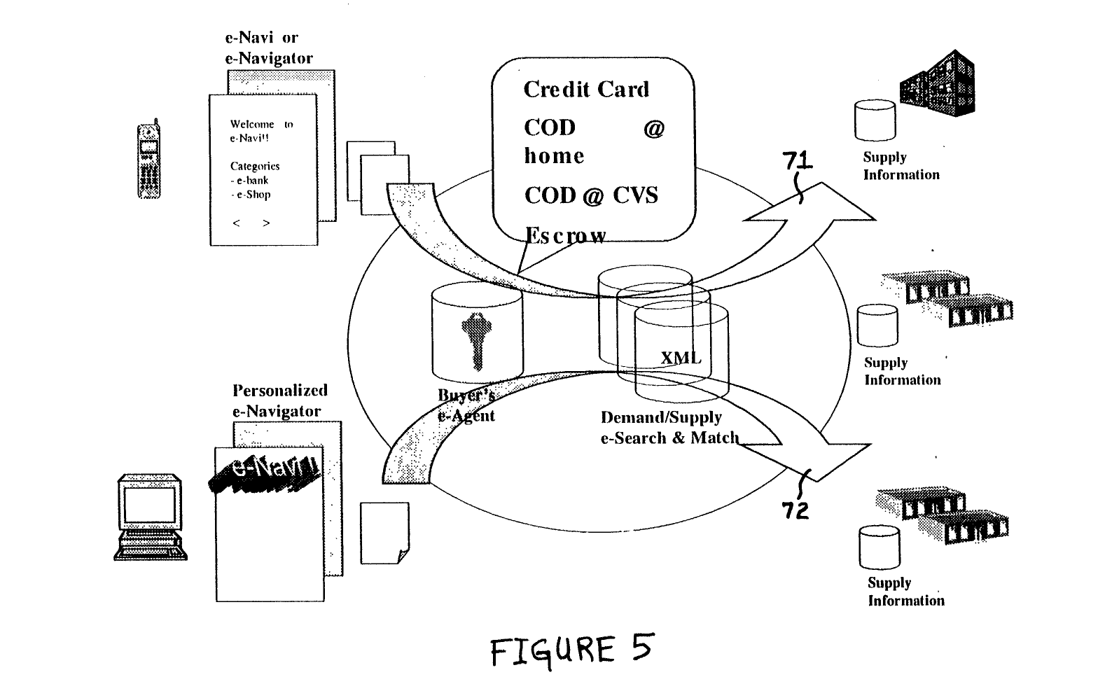

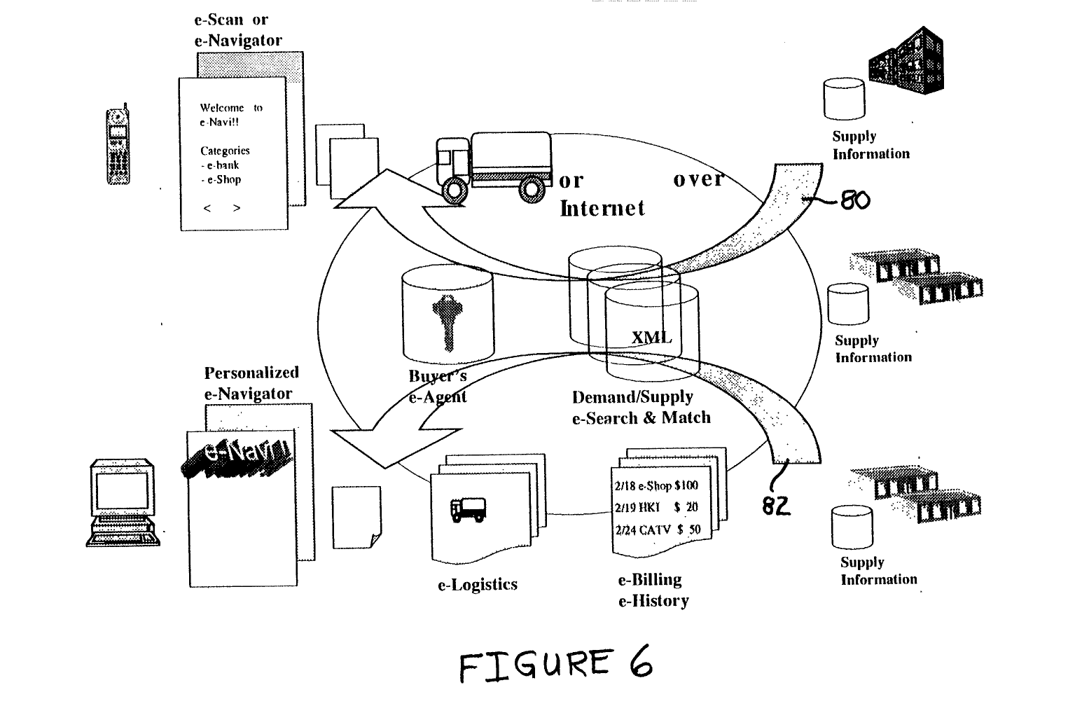

With reference to FIGS. 5 and 6, the arrows 71 and 72 show information flow from the customer to the suppliers of products and services. This information can include credit card information and home address. Once a transaction is to be completed, FIG. 6 indicates by means of the arrows 80 and 82 the flow of goods and services to the customer.

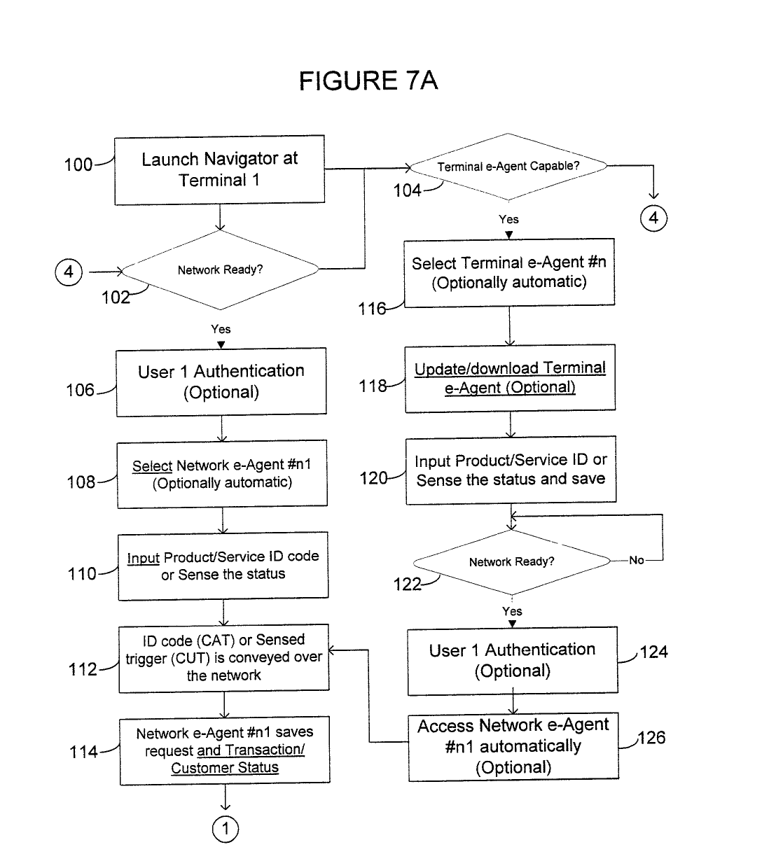

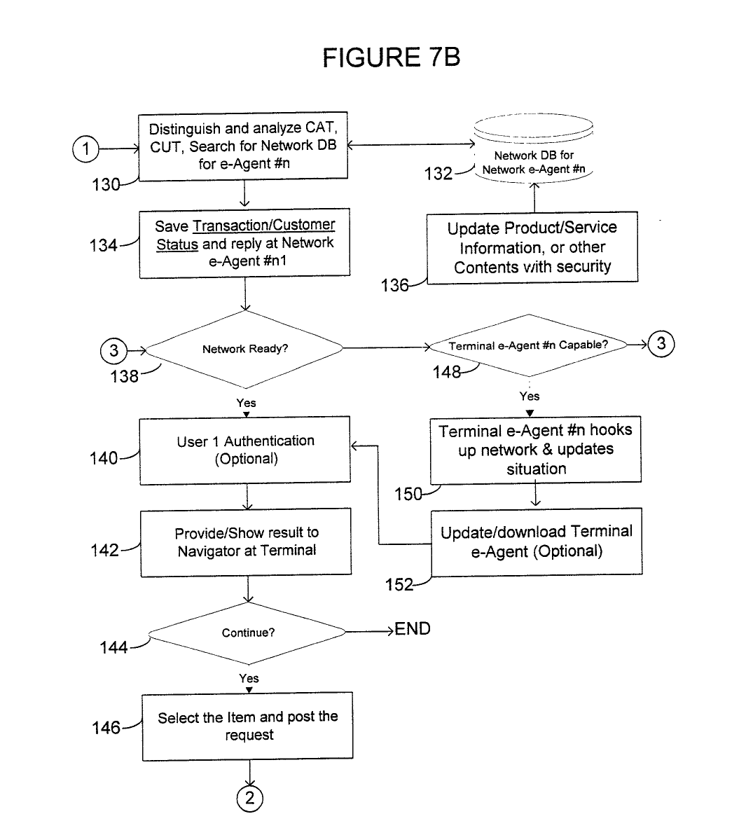

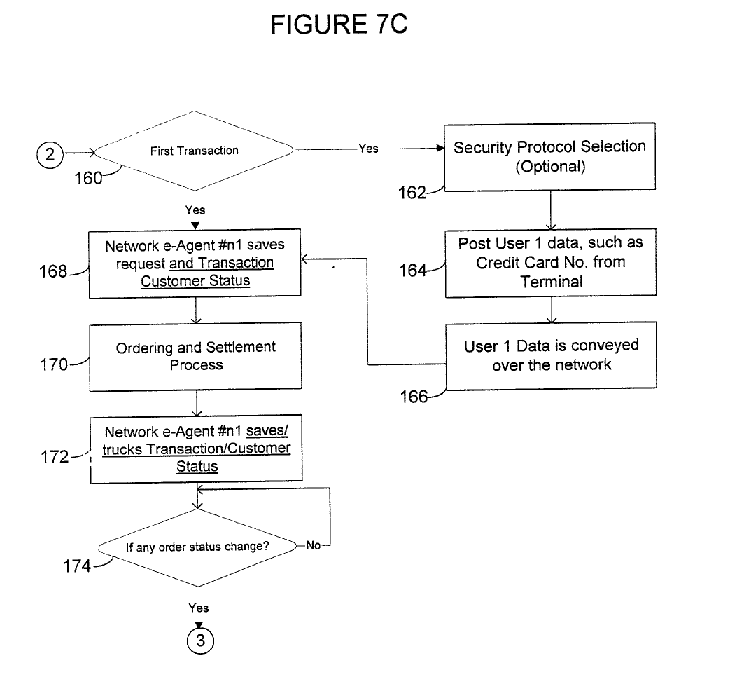

The remaining FIGS. 7A-7C are flow charts of various steps that are performed by the method and system of the present invention. With reference to FIG. 7A, the step 100 begins the process at the customer tool by launching the navigator software. The remaining steps 102-126 are involved in allowing the terminal e-agent determine what the readiness of the components of the system is, including network availability, and once communication is established, to provide such standard functions as user authentication (step 106), selection of the network e-agents (step 108), and remaining steps which are involved with the product or service identification and the attendance to effectuate the transaction.

With reference to FIG. 7B and the steps 130-152, respond to CAT or CUT triggers from the personal agent 14. The e-agent initiates (at step 130) communication with the network database for the agent (132) which is constantly updated with product and service information or other content as indicated at 136, to thereafter allow various transactions with customers as indicated in the remaining steps of this Figure.

Historical as well as transactional steps involved with ordering and reordering of goods and services as well as saving personal information are further explicated in self-explanatory fashion by the steps 160-174 of FIG. 7C.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system for effecting procurement of desired items which include products or services or information content, the system comprising:
a portable, hand-held user tool, comprising a facility for reading, storing and forwarding identification indicia appearing on or in proximity to the desired items;
a central agent facility configured to communicate with a plurality of the user tools and constructed to receive from the hand-held user tools the identification indicia;
a database associated with the central agent facility that correlates the desired item identification information received from the hand-held user tools with corresponding supply source information for the desired items available at or from a plurality of suppliers;
a data gathering facility associated with the central agent facility which communicates to the suppliers users requests for the desired items and receives information from the suppliers relevant thereto; and
wherein the central agent facility communicates to the user tools selective information pertaining to the desired items.

2. The system of claim 1, in which the user tool comprises having a sensor, whose mode of operation selected from the operation group including: optical, magnetic, infrared, sound and bio-sensor.

3. The system of claim 2, in which the sensor is incorporated in another device and that other device is selected from the group including: a mobile phone, a mobile terminal, a two-way pager, a PC mouse, a CATV set top box, a digital camera, a watch, and a game.

4. The system of claim 1, in which the tool has a memory for the storage therein of the identification indicia for later retrieval.

5. The system of claim 1, in which the user tool is operable in an off-line mode.

6. The system of claim 1, in which the user tool is operable in an on-line mode.

7. The system of claim 1, in which the identification indicia appears on an item selected from the group or comprising: products, services, or information.

8. The system of claim 1, in which the identification indicia is a digital representative image of a corresponding product.

9. The system of claim 1, in which the agent facility comprises a plurality of selectable facilities which can be selected by a user with the user tool.

10. The system of claim 9, in which the agent facility comprises a plurality of auxiliary facilities.

11. The system of claim 10, in which the auxiliary facilities include an e-rate facility.

12. The system of claim 10, in which the auxiliary facilities include an e-care facility.

13. The system of claim 10, in which the auxiliary facilities include an e-billing and history facility.

14. The system of claim 10, in which the auxiliary facilities include an e-logistics facility.

15. The system of claim 10, in which the auxiliary facilities include an e-search and match demand/supply facility.

16. The system of claim 1, in which the customer tool comprises an e-navigator software facility which effects communication with the agent facility.

17. The system of claim 1, in which the user tool includes an automatically triggered feature that triggers communication with the agent facility without an active step being taken by the user.

18. The system of claim 1, including a virtual browsing facility enabling a user to browse databases of the suppliers without directly accessing the Internet.

19. The system of claim 1, including a facility for rapid submission of reorders and direct commerce.

20. The system of claim 1, further including a facility for causing the central agent to react based on bio feedback transmitted to it by the user tool.

21. The system of claim 10, further including a navigational facility which monitors the location of the user and provides navigational assistance to the user via the agent facility and the suppliers.

22. The system of claim 1, including a facility which responds to requests from the user tool by a communication mode selected from the group including: e-mail, facsimile, letter and automatically triggered voice telephone messages.

23. A method for effecting procurement of desired items which include products or services or information content, the method comprising the steps of:
providing users with a portable, hand-held user tool, comprising a facility for forwarding identification indicia defining the desired items;
providing a central agent facility configured to communicate with a plurality of the portable user tools and constructed to receive from the user tools the identification indicia;
providing in conjunction with the central agent facility a database that correlates the desired item identification information received from the user tools with corresponding supply source information for the desired items available at or from a plurality of suppliers;
operating the central agent facility to gather from the plurality of suppliers information responsive to the user requests for the desired items and receiving from the plurality of suppliers information relevant thereto; and
communicating from the central agent facility to the user tools selective information pertaining to the desired items.

24. The method of claim 23, in which the identification indicia comprises a symbol appearing on or in proximity to the desired items.

25. The method of claim 23, in which the identification indicia comprises at least a model number of a product or service and including recording in the user tool the model number and the user tool forwarding a voice message of the model number to the central agent facility, and including the central agent facility decoding from the received voice messages the model numbers.

26. The method of claim 23, further including operating the user tool in both on-line and off-line modes.

27. The method of claim 23, further comprising providing responses to user requests at a display provided on the user tools.

28. The method of claim 23, including providing responses to requests from the user tools by communicating to users by means of a communication mode selected from a group including: e-mail, facsimile, letter and automatically triggered voice telephone messages.

29. The method of claim 23, in which the user tool comprises a sensor that is able to read identification indicia appearing on or in proximity to the desired items and including operating the user tool to read, store and forward the identification indicia to the central agent facility.
